(19) United States
(12) Patent Application Publication
(10) Pub. No.: US 2026/0346681 A1
(43) Pub. Date: Nov. 5, 2026

(54) HEAT EXCHANGER, METHOD FOR MANUFACTURING A HEAT EXCHANGER, AND ELECTRIC WATER HEATER

(71) Applicant: Webasto SE, Stockdorf (DE)

(72) Inventors: Markus Gey, Stockdorf (DE); Katrin Hofmann, Stockdorf (DE); Jan Steffens, Stockdorf (DE); Bengt Meier, Stockdorf (DE); Peter Mogl, Stockdorf (DE); Perry Inderfurth, Stockdorf (DE); Peter Neidenberger, Stockdorf (DE); Tobias Haimerl, Stockdorf (DE); Roman Mielke, Stockdorf (DE); Stefan Behringer, Stockdorf (DE)

(21) Appl. No.: 19/124,634

(22) PCT Filed: Aug. 29, 2023
(86) PCT No.: PCT/EP2023/073646

§ 371 Date: Apr. 25, 2025

(30) Foreign Application Priority Data
Oct. 27, 2022 (DE) 10 2022 128 487.5

(51) Int. Cl. B60H 1/22; H05B 3/03

(52) U.S. Cl. CPC B60H 1/2215; H05B 3/03

(57) ABSTRACT

Disclosed is a heat exchanger for an electric water heater, said heat exchanger comprising a heating conductor, a heat transfer element and an insulation element which is arranged between the heating conductor and the heat transfer element and which serves to electrically insulate the heating conductor from the heat transfer element and vice versa, wherein the insulation element is arranged on the heat transfer element by means of a thermally conductive and elastic adhesive.

### TECHNICAL FIELD

The invention relates to a heat exchanger, a method for manufacturing a heat exchanger and an electric water heater.

### TECHNICAL BACKGROUND

Heat exchangers are typically used to transfer heat from a heating element to a heat-conducting medium. Such heat exchangers are usually installed in heaters in which the heat generated by a heating conductor is transferred to a heat transfer element, which in turn transfers the heat to a medium. The medium used here is water or coolant, for example, which is why these heaters are also referred to as water heaters and, in the case of an electrically operated heating conductor, as electric water heaters. A typical field of application for such electric water heaters is in motor vehicles, for example, where they are used to heat the passenger compartment.

In order to achieve electrical insulation between the heating conductor and the heat transfer element and, in particular, the medium, an insulation element is usually arranged in the heaters. As already mentioned, this insulation element, also known as an insulating layer, should have an electrically insulating effect on the one hand, but also be a good heat conductor on the other.

This means that only a few materials are suitable. These are usually plastics or ceramics, but they usually exhibit a mismatch in thermal expansion, i.e., different linear expansions occur during heating during operation and production processes, which can cause the insulation layer to peel off and/or cracks to form.

### SUMMARY OF THE INVENTION

An object of the invention therefore is to provide a heat exchanger, a method and an electric water heater, with the aid of which mechanical stresses are at least reduced during operation of the heater.

With regard to the heat exchanger, the object is solved in accordance with the present invention by a heat exchanger comprising the features of claim 1. With regard to the method, the object is solved in accordance with the present invention by a method for manufacturing a heat exchanger comprising the features of claim 7. With regard to the electric water heater, the object is solved according to the present invention by an electric water heater having the features of claim 6. Furthermore, a motor vehicle or construction machine or watercraft is disclosed and claimed in the context of this application, which has an electric water heater according to the invention.

Preferred embodiments, developments and variants are the subject of the dependent claims. The advantages and preferred embodiments listed with regard to the heat exchanger are to be applied mutatis mutandis to the method and to the electric water heater and vice versa.

The term water heater is to be understood broadly in this document. The term water heater refers to a heater that can be operated with any type of water as a medium, i.e., also with coolant (water-ethylene glycol mixture).

Specifically, the object is solved by a heat exchanger for an electric water heater, which has a heating conductor and a heat transfer element. The heating conductor may, for example, be an electrical heating conductor. The heat transfer element may, for example, be a metal heat transfer element.

Furthermore, the heat exchanger has an insulation element that is arranged between the heating conductor and the heat transfer element. This arrangement can also be referred to as a “sandwich” construction. The insulation element serves to electrically insulate the heating conductor from the heat transfer element and vice versa, so that no electrical short circuit can occur between these two components.

Furthermore, the insulation element is attached to the heat transfer element by means of a thermally conductive and elastic adhesive.

The advantage of this design is that, on the one hand, the required heat conduction of the heat exchanger is not impaired by the adhesive due to both the thermally conductive and elastic adhesive. On the other hand, the elastic properties of the adhesive compensate for mechanical stress between the individual components and in particular between the insulation element and the heat transfer element, which occurs during operation and the associated heating of the heat exchanger. In other words, the insulation element may be arranged directly on the heat transfer element by using the elastic adhesive.

According to one embodiment, a joining gap is formed between the heat transfer element and the insulation element, in which the adhesive is arranged. This does not impair the “sandwich” construction of the heat exchanger, which has been considered necessary and is described above, and also enables the adhesive to be positioned precisely.

In a further embodiment, a geometric dimension of the joining gap is designed based on at least one of the following parameters:
heat conduction of the adhesive;
thermal expansion of the insulation element and the heat transfer element;
stretchability of the adhesive;
an operating temperature of the heat exchanger;
a continuous operating temperature of the adhesive and
an adhesive property of the adhesive on the materials of the insulation element and the heat transfer element.

For the purposes of this application, the term “thermal conductivity of the adhesive” can be understood to mean the general thermal conductivity of the adhesive. The more thermally conductive the adhesive is, for example, the thicker the joining gap can be designed in order to be able to introduce as much adhesive as possible into the joining gap for mechanical fixing of the components.

For the purposes of this application, the term “thermal expansion of the insulation element and the heat transfer element” can be understood as the extent to which these two components expand during operation, i.e., when heated. The greater the thermal expansion of the components, the more elastic the adhesive must be in order to compensate for the mechanical stresses.

For the purposes of this application, the term “stretchability of the adhesive” can be understood to mean how elastic the adhesive is, so that it can then be selected according to the mechanical stresses that occur or are to be expected and the joining gap can be designed accordingly.

For the purposes of this application, the term “operating temperature of the heat exchanger” can be understood to mean how hot the heat exchanger becomes during operation. The hotter it gets, the higher the heat resistance of the adhesive must be or the greater the expansion of the components must be expected, to which the joining gap must be adapted. Typical examples of temperatures are −40 degrees Celsius as the lower thermal limit and the maximum operating temperature of the working temperature as the upper thermal limit.

For the purposes of this application, the term “continuous operating temperature of the adhesive” can be understood to mean the continuous temperature to which the adhesive can be exposed without losing both its thermally conductive and elastic properties within acceptable tolerances.

For the purposes of this application, the term “adhesive property” can be understood to mean that the adhesive must be designed to adhere to different materials, for example ceramics and metal.

In order to optimize the aforementioned “sandwich” structure, the heat transfer element is arranged on a first side of the insulation element and the heating conductor is arranged on a second side of the insulation element, wherein the first side faces the second side.

According to one embodiment, the insulation element comprises a ceramic or is made of a ceramic. In particular, the insulation element can be designed as a ceramic substrate (e.g., as a plate-shaped support element), for example made of Al₂O₃, with a heating conductor layer screen-printed on the substrate. The insulation element with the heating conductor arranged on it then forms a heating element. The heating conductor may, for example, be formed as a metallization of a resistance alloy, which represents the corresponding heating resistor. An iron-nickel alloy or a nickel-chromium alloy may be considered. An insulating interruption ensures the structuring of long conductor paths from the otherwise flat applied and later baked layer and can, for example, be created during application by means of a screen printing process. The ceramic substrate may be a ceramic support plate. According to aspects of the invention, this embodiment of a heating element is preferred.

The heat exchanger can preferably also have several heating elements. In this case, each individual heating element or the associated insulation element is arranged on the heat transfer element by means of the adhesive.

Furthermore, the heat transfer element may be made of steel or aluminum, preferably aluminum. The heat transfer element may have a deep-drawn base component and a flat cover component in the form of a support plate. The support plate may also be deep-drawn in order to form nubs to be described below according to embodiments. A flat circumferential edge of the base component is soldered or welded to the cover component in order to close off a flat fluid chamber formed therebetween, through which the coolant or water flows. A turbulator may be used in the fluid chamber, which mixes the fluid flowing through and supports the transfer of heat to the fluid. The fluid can flow into the fluid chamber through a fluid inlet and flow out again through the fluid outlet after heating.

According to a specific embodiment, a geometric dimension of the joining gap, in particular a thickness of the same or of a layer of the adhesive arranged therein, can be defined by a number of spacers. The spacers can be in the form of glass beads in the adhesive, foil particles or nubs in or protrusions on the heat transfer element. In the bonded state, the spacers can be embedded in the (hardened) adhesive or arranged in areas that are kept free of the adhesive. The spacers may form contact surfaces or contact points for the insulation element. When pressing the adhesive through the insulation element, which is pressed against the heat transfer element during production, for example, the spacers may serve as stop points/surfaces for the insulation element, thereby supporting and simplifying the production process. The spacers can also be formed by the material of the adhesive itself, if individual raised elements are formed on the surface of the heat transfer element by local application and curing from the adhesive before the actual application step is carried out to form the adhesive layer.

A height of the spacers can be in a range from 100 μm to 450 μm, preferably between 200 μm and 350 μm. In the example case of the nubs or protrusions, the height is a distance between the support point for the insulation element (or its first side, which is opposite a second side on which the heating conductor(s) are arranged) and a surface of the heat transfer element or, according to embodiments, the flat support plate of the heat transfer element forming this surface. In the case of the glass beads or the foil particles, the height may correspond to their diameter.

A development of this aspect provides that the spacers have support points or surfaces as described and have at least two different overall heights, wherein first spacers arranged closer to a center of the insulation element have a comparatively lower overall height, and second spacers arranged closer to one of the edges of the insulation element have a greater overall height in comparison, so that a layer thickness of the adhesive near the edges is greater than near the center.

This measure eliminates or at least reduces the strict requirements for tolerances on the flatness of the adhesive surfaces on the heat exchanger, while improving process reliability and simplifying production overall. Furthermore, the smaller thickness of the joining gap in the middle of the respective insulation element, i.e., away from its outer edges, results in more efficient heat transfer and thus thermal relief for the heating elements.

According to exemplary embodiments, the spacers can be formed as mentioned above as nubs formed in a surface of the heat transfer element. The nubs may also be formed by the adhesive itself, as described above, for example by applying adhesive nubs to the surface of the heat transfer element with subsequent curing, while the large-area application of the adhesive is carried out only subsequently to produce the actual adhesive layer, forming the joining gap. Alternatively, the nubs may be formed by the heat transfer element itself, for example by deep drawing the corresponding support plate. In this case, the nubs can be formed in one piece or integrally with the heat transfer element.

This embodiment offers several advantages: on the one hand, the nubs can be formed very precisely using the manufacturing methods described so that the local thicknesses can be set precisely. Furthermore, the production can be integrated very well into the manufacturing process of the heat transfer element, which saves costs and effort.

If the aspects of varying (increasing) layer thicknesses from the center to the edges of the insulation element with the help of spacers are combined with the concept of nubs, special advantages arise: the local, variable adjustment of the layer thickness, e.g., the increased thickness in the area close to the edges of the insulation element, makes it possible to balance or compensate for the shear during thermal expansion between the joined surfaces. In the central areas, the thickness (due to the height H of the nubs) of the adhesive is reduced in order to increase thermal conduction. In addition, the nubs themselves can increase the thermal conduction when they are in more or less direct contact with the insulation element.

The latter advantage can be exploited according to a further aspect of the present invention. According to this aspect, a first side of the insulation element faces the nubs and the heating conductor is arranged on an opposite, second side of the insulation element. Furthermore, a location can be defined in the heating conductor at which the greatest heat release can be determined during operation, i.e., a local maximum (peak) or a maximum for the heating element in question. In this case, one of the nubs can now be placed in a position on the first side opposite the location of the greatest heat release on the second side.

This measure can achieve a more homogeneous heat distribution and thus reduced thermal stresses in the insulation element (ceramic), a reduced local heat load in the heating conductor and a more efficient heat transfer to the heat transfer element.

An analogous aspect concerns the further connection of a power switching component to the heat transfer element. The heat exchanger may further comprise this power switching component, which comprises a printed circuit board substrate with a first side and a second side and power switching elements arranged on the second side. The printed circuit board substrate may be arranged on the heat transfer element in the same way as the insulation element by means of the thermally conductive and elastic adhesive. At least one temperature sensor is also arranged at a location on the second side of the printed circuit board substrate. One of the nubs is placed in a position on the first side of the printed circuit board substrate opposite the location of the temperature sensor.

This aspect of the invention results in the following advantages
an adhesive 10 with comparatively lower thermal conductivity can be used, which results in a cost advantage per quantity of adhesive applied;
a greater layer thickness or thickness of the joining gap can be accepted when the layer thickness away from the nubs is increased, which results in increased process capability or a larger tolerance window for the layer thickness;
the affected electronic components can be replaced by alternative components, e.g., with lower costs or higher performance, which in turn is made possible by a higher permissible power dissipation;
the service life of the thermally stressed electronic components can be increased;
temperature sensors can be better connected to the point to be measured (e.g., heat exchanger), which ensures greater accuracy and response time of the measurement.

Alternatively or additionally, one (other) of the nubs may also be placed in a (different) position on the first side of the printed circuit board substrate opposite a location where one of the power switching elements is arranged on the second side of the printed circuit board substrate. The advantage is the same as described above with regard to the location of the greatest heat release, because the high-voltage power switching element in operation itself also represents a considerable source of heat, which can be dissipated with advantage by the nearby nub.

The water heater preferably has a heat output of at least 5 KW, preferably at least 7 KW, for example at least 9 kW. The heating power is preferably less than or equal to 13 kW in each case. The operating voltage with which the water heater is operated, which can be equal to the on-board voltage of an electrically powered vehicle, is greater than or equal to 400 V, preferably greater than or equal to 700 V, for example 800 V, 900 V or 1000 V. Specifically, the object directed to the method is solved by a method for manufacturing a heat exchanger, wherein the method comprises the following steps:
arranging a heating conductor on an insulation element;
providing a heat transfer element
applying a thermally conductive and elastic adhesive on one side of the heat transfer element or on one side of the insulation element on which the heating conductor is not arranged;

The step of arranging a heating conductor on an insulation element preferably involves applying the heating conductor to the insulation element by screen printing. The insulation element with the heating conductor applied then forms a heating element.

The thermally conductive and elastic adhesive is preferably applied to the first side of the insulation element (the side opposite the heating conductor).

According to one embodiment of the method, the method further comprises the steps of:
defining a joining gap between the heat transfer element and the insulation element and
arranging the adhesive in the joining gap.

For the purposes of the present application, the term “define” can be understood to mean that the joining gap is realized, for example, by a defined contact pressure in which the two elements are pressed together, for example, in molds provided for this purpose.

Preferably, the adhesive is applied to the insulation element, in particular to the first side of the insulation element (the side of the insulation element opposite the heating conductor). For example, the insulation element on which the heating conductor is arranged lies in an adhesive device in such a way that the heating conductor is directed downwards. The heat transfer element is then placed on top, screwed to a frame and may also be loaded with weights in the middle.

It is also conceivable that spacers (glass beads in the adhesive, foil particles, nubs in the heat transfer element) could be used as described above to adjust the joining gap.

If the spacers are nubs, for example, they can be manufactured as described below: for example, the surface of the heat transfer element to be joined can be a deep-drawn plate-shaped sheet metal component. The nubs are stamped into this sheet metal component in a pressing or punching tool, which has embossments corresponding to the nubs. Alternatively, it is also conceivable to manufacture the nubs in a process involving aluminum casting and CNC post-processing.

The nubs can be formed very precisely using the manufacturing methods described so that the local thicknesses can be set precisely. Furthermore, the production can be integrated very well into the manufacturing process of the heat transfer element, which saves costs and effort. Otherwise, the advantages are the same as described above.

In a further embodiment, the method further comprises the step of:
Designing a geometric dimension of the joining gap based on at least one of the following parameters:
   heat conduction of the adhesive;
   thermal expansion of the insulation element and the heat transfer element;
   stretchability of the adhesive;
   operating temperatures of the heat exchanger;
   a continuous operating temperature of the adhesive and
   an adhesive property of the adhesive on the materials of the insulation element and the heat transfer element.

### BRIEF DESCRIPTION OF THE DRAWINGS

An exemplary embodiment of the invention is explained in greater detail below with reference to the drawings. These show, in a partially simplified representation, in:

FIG. 1 a Sketched Section Through a Heat Exchanger According to the Invention;

FIG. 2 based on the general structure as shown in FIG. 1, a sketched section through the heat transfer element and the insulation element of the heat exchanger or heating element, according to an exemplary embodiment with spacers;

FIG. 3 a cross-section through a heat transfer element with a nub formed therein as a spacer according to an exemplary embodiment compatible with FIG. 2;

FIG. 4 a perspective view of a heat exchanger without heating element, in which nubs are formed as shown in FIG. 3;

FIG. 5 plan view of the heating elements and a power switching component mounted on the heat exchanger in FIG. 4.

### DETAILED DESCRIPTION OF PREFERRED EXEMPLARY EMBODIMENTS

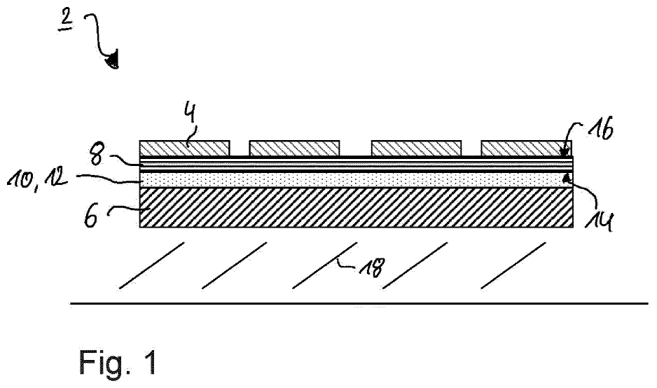

FIG. 1 shows a section through a heat exchanger 2 according to the invention for an electric water heater not shown. The heat exchanger 2 has a heating conductor 4, of which only the section of several windings is shown.

Furthermore, the heat exchanger 2 has a heat transfer element 6. An insulation element 8 is arranged between the heating conductor 4 and the heat transfer element 6 and serves to electrically insulate these two components. The insulation element 8 is arranged on the heat transfer element 6 by means of a thermally conductive and elastic adhesive 10. In particular, in the exemplary embodiment shown in FIG. 1, the adhesive 10 is arranged in a joining gap 12, which is formed between the insulation element 8 and the heat transfer element 6.

Furthermore, as can be seen from FIG. 1, the heat transfer element 6 is arranged on a first side 14 of the insulation element 8 and the heating conductor 4 is arranged on a second side 16 of the insulation element 8 in order to form the “sandwich” construction already mentioned at the outset.

During operation of the heat exchanger 2, the electrical heating conductor 4 is heated and the heat is transferred to the insulation element 8, which is usually designed as a ceramic. The heat is then transferred from the insulation element 8 via the thermally conductive adhesive 10 to the heat transfer element 6, which in turn transfers the heat to a medium 18, e.g., water, which is only schematically sketched.

The invention is not limited to the exemplary embodiment described above. Rather, other variants of the invention can also be derived from it by a person skilled in the art without departing from the object of the invention. In particular, all the individual features described in conjunction with the exemplary embodiment can also be combined with one another in other ways without departing from the subject of the invention.

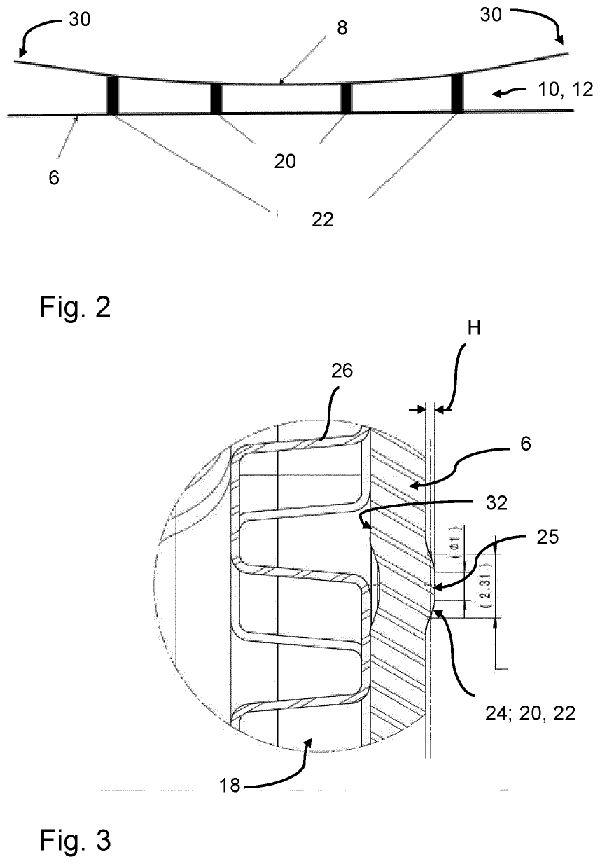

A further development of the exemplary embodiment shown above is shown in schematic view in FIG. 2. For the sake of simplicity, only the insulation element 8 of the heating element and the heat transfer element 6 of the heat exchanger 2 are shown, between which the joining gap 12 with the adhesive 10 applied therein extends. The heating conductor 4 or the medium 18 from FIG. 1 are omitted in FIG. 2, for example. As described, spacers shown very schematically in FIG. 2 (glass beads in the adhesive, foil particles, nubs in or protrusions on the heat transfer element 6) can be used to adjust the joining gap 12. In principle, according to exemplary embodiments, these can be of the same height. In the exemplary embodiment of FIG. 2, however, spacers 20, 22 of different heights are provided.

In order to produce a joining gap that is not too thick, a narrow tolerance for the evenness of the adhesive surfaces on the heat exchanger would be required in order to offer sufficient process reliability (homogeneous and large-area distribution of the adhesive between the surfaces). In fact, however, the greatest differences in length between the insulation element 8 and the heat transfer element 6 occur at the edge of the bonding area in the event of temperature changes due to possibly different expansion coefficients, while the center is in essence the starting point for the mutual displacements. A basic idea of the exemplary embodiment is therefore to make the joining gap thicker near the edges of the heating element or the insulation element 8 and comparatively thinner in the middle.

FIG. 2 shows that spacers 22 on the outside (i.e., closer to the edge of the insulation element 8) have a greater height than spacers 20 on the inside (i.e., closer to the center). This increases the thickness of the layer of adhesive 10 precisely at those critical points where the greater length differences in thermal expansion occur and where this layer would therefore be subjected to the greatest stress. This measure eliminates or at least reduces the strict requirements for tolerances on the flatness of the adhesive surfaces on the heat exchanger, while improving process reliability and simplifying production overall. It should be noted that the height H of the support points or surfaces 25 of the spacers can be produced very precisely. A deflection of the overlying heating element—as shown slightly exaggerated in FIG. 2—is perfectly acceptable. Furthermore, the smaller thickness of the joining gap 12 in the middle of the respective insulation element 8 results in a more efficient heat transfer and thus a thermal relief of the heating elements.

According to exemplary embodiments of the method according to the invention, the thickness may also be adjusted by, among other things:
the adhesive comprises a filler (e.g., glass beads) with a defined size and shape distribution, wherein this filler serves as a mechanical spacer when pressing the adhesive 10 between the adjacent surfaces of insulation element 8 and heat transfer element 6;
the device for pressing the adhesive 10 has a geometric stop outside it, which acts as a mechanical spacer;
the device for pressing the adhesive 10 applies a defined force profile, which ultimately results in a defined layer thickness of the adhesive 10; or
the adhesive 10 is brought to the defined layer thickness before pressing using an auxiliary device (e.g., doctor blade/screen printing) and is no longer geometrically altered during subsequent pressing.

However, a particularly advantageous exemplary embodiment, illustrated in FIG. 3, provides for the surface of the heat transfer element 6 to be joined to be equipped with a number of nubs 24 as spacers 20 or 22, as can be seen in abstract form in FIG. 2. The nubs 24 are formed in one piece with the heat transfer element 6. The opposite surface of the insulation element 8 of the heating element can now come to rest on these nubs when the adhesive 10 is pressed (corresponding to a form fit). The raised surfaces of the nubs 24 thus serve as an impact or contact surface 25 for the surface of the insulation element 8. It is possible that in the case of very small particles or beads (e.g., ceramics, etc. with diameters of e.g., 60 μm) present in the adhesive, these remain between the bearing surface of the spacers and the first side (the rear side) of the insulation element (are “clamped in”, so to speak) in the final state of pressing and are not driven out of the narrow gap. The adhesive layer thickness then increases accordingly by a small value. In this respect, the nub height H determines the measure for the layer thickness of the adhesive 10. FIG. 3 only shows the side of the heat transfer element 6; the insulation element 8, which is not shown, is approached from the right in FIG. 3 and pressed on when the adhesive 10 is applied in between.

FIG. 3 shows a sectional view through the heat transfer element 6 including the fluid chamber 32 formed by it with the medium 18 or fluid (e.g., water) flowing therein and a turbulator 26 arranged therein for mixing the medium 18 and for intensifying the heat transfer.

Manufacture can be carried out as described below: for example, the surface of the heat transfer element 6 to be joined can be a deep-drawn plate-shaped sheet metal component. The nubs 24 are stamped into this sheet metal component in a pressing or punching tool, which has embossments corresponding to the nubs 24. Alternatively, it is also conceivable to manufacture the nubs 24 in a process involving aluminum casting and CNC post-processing. In the exemplary embodiment, the nubs can have an overall height H of 0.32 mm, the diameter of the contact surface 25 can be 1 mm, and the total nub diameter (with flanks) can be 2.31 mm.

Returning to FIG. 2, it is possible to adjust the inclination of the surfaces to be joined to each other by setting the height H of the nubs 24 in particular. This allows the above-mentioned local, variable adjustment of the layer thickness, e.g., the increased thickness in the area close to the edges 30 of the insulation element 8, in order to compensate for the shear during thermal expansion between the joined surfaces. In the central areas, the thickness (due to the height H of the nubs) of the adhesive 10 is designed to be lower in order to increase thermal conduction. The nubs 24 can also be formed very precisely using the manufacturing processes described so that the local thicknesses can be set precisely. Furthermore, the production can be integrated very well into the manufacturing process of the heat exchanger 2, which saves costs and effort.

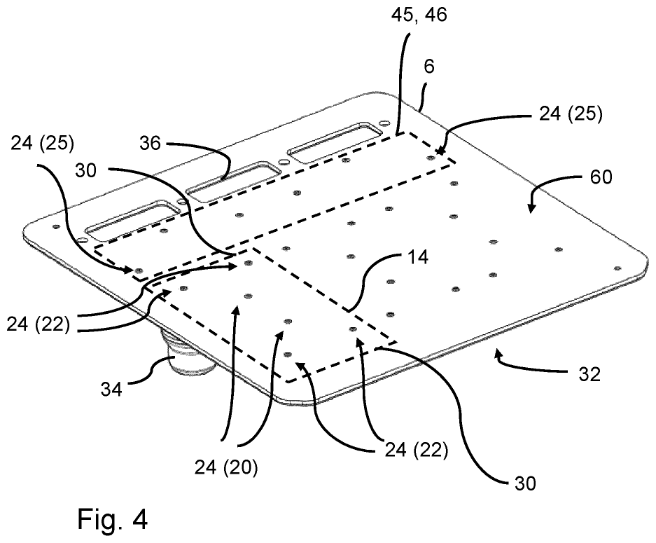

In FIG. 4, a perspective view of the heat exchanger 2 without the heating element or the heat transfer element 6 is shown, wherein the direction of view is directed towards the largely flat support plate 60 of the heat transfer element 6, which forms the surface for joining with the insulation element 8 of the heating element. A total of 3 heating elements (i.e., 3 insulation elements 8) are added in this exemplary embodiment, as well as a printed circuit board providing a power switching component for operating the heating elements (not shown).

In the support plate 60 of the heat transfer element 6, a number of nubs 24 are arranged as spacers 20 or 22 distributed over its surface as described. The position of the first side 14 of one of the three insulation elements 8 when it is joined to the heat transfer element 6 is also shown in dotted lines. It can be seen that the first nubs 24 or spacers 20 (here two per heating element) are positioned close to the center of the first side 14, while the second nubs 24 or spacers 22 (here four per heating element) are positioned close to their edges 30. The two edges 30 at the longitudinal ends of the insulation elements are relevant here, as the shear has a greater effect in the longer longitudinal extent than in the transverse direction.

In addition to the fluid chamber 32, FIG. 4 also shows a connection piece 34 for the fluid inlet or outlet as well as several through-openings formed in the support plate 60 for a feed-through of electrical conductor tracks from a control module (not shown) to the power switching component (not shown).

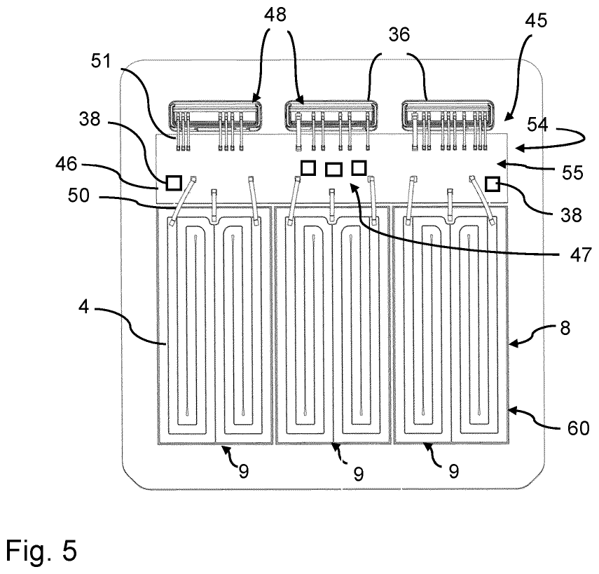

The exemplary embodiment of FIG. 4 also shows a further, independent aspect of the present invention, which can be implemented separately from the basic idea of the exemplary embodiment of FIG. 2. Here, the nubs 24 (25) in FIG. 4 are considered purely by way of example. These are arranged within an outline (drawn in dotted lines in FIG. 4) on the heat transfer element 6, which corresponds to the power switching component 45 to be attached, which is designed as a printed circuit board substrate 46 with power switching elements 47 (shown only schematically) arranged thereon for operating the heating elements 9 (see FIG. 5). The power switching component 45 comprises, for example, an FR4 substrate or the like as printed circuit board substrate 46, which, like the heating elements 9, is bonded to the substantially flat support plate 60 of the heat transfer element 6 and, like the latter, dissipates the heat generated by the power switching elements 47 during operation to the medium flowing through the fluid chamber 32 via the thermally conductive adhesive 10 and the heat transfer element 6.

In the aspect under consideration here, the basic idea is to place the nubs 24 (25) directly contacting the printed circuit board substrate or the insulation element under those areas that correspond to the greatest heat release of the joined electronic assembly (in the exemplary embodiments, the heating element 9 or the power switching component 45). As a result, these areas are locally better thermally connected or deheated than their surroundings. In the case of the power switching component 45, for example, such an area corresponds exactly to the power switching elements 47 (power MOSFETs or IGBTs). However, the heating elements are more or less completely covered with heating conductors, so that there are fewer local differences in the heat release here, but heat peaks can also occur here depending on the structure, which can be efficiently reduced with a suitable positioning of the nubs.

In the exemplary embodiment in FIG. 4, the positions of the nubs 24 (25) correspond to those of the temperature sensors 38 on the power switching component 45, as can be seen in comparison with FIG. 5. FIG. 5 shows a plan view of the three heating elements 9 and the power switching component 45 in the state mounted on the support plate 60 of the heat exchanger 2. In the exemplary embodiment, the heating elements 9 are designed as a ceramic substrate (as a carrier element), for example made of Al₂O₃, with a screen-printed heating conductor layer. The heating conductor layer is designed as a metallization made of a resistance alloy and provides the corresponding heating resistance. An insulating interruption ensures the structuring of long heating conductors 4.

The power switching component 45 has the printed circuit board substrate 46 with a first side 54 facing the heat transfer element 6 and an opposite, second side as well as a number of power switching elements 47, which are formed on the second side of the printed circuit board substrate, for example IGBTs or power MOSFETs, with which the heating elements 9 can be operated under PWM control. Corresponding connection pads of the heating conductor 4 or connection points on the heating conductor 4 are connected to the power switching elements on the power switching component 45 via bond connections 50 for this purpose.

The power switching component 45 also has the temperature sensors 38 arranged on the second side of the printed circuit board substrate 46, which can detect a temperature for the purpose of controlling the heating operation. In the exemplary embodiment, their position on the power switching component 45 or on the second side 55 of the printed circuit board substrate 46 is comparatively close in each case to the fluid inlet and the fluid outlet (see the connection piece 34 in FIG. 4) on the rear side of the support plate 25, in order to be able to detect temperature values which are representative of the fluid temperatures at the fluid inlet and at the fluid outlet, as a result of which a current heating of the fluid can be determined.

The power switching component 45 is connected via further bond connections 51 to respective connections which are set up on three lead frames 48 (punched grids), which are assigned to the respective heating elements 9. The bond connections 51 include electrical lines for the power supply (in the high-voltage range, e.g., 60 V or more, preferably 400 V or more, further preferably 800 V or more, e.g., 900 V or 1,000 V), for controlling the power switching elements 47 and for communication with the temperature sensors. The lead frames 48 are arranged in through-openings 36 of the support plate 60.

The temperature sensors 38 of FIG. 5 are assigned to the nubs 24 (25) of FIG. 4 on the rear side of the power switching component 45, i.e., their corresponding positions on the first side 54 and on the second side 55 match. Here, however, the temperature sensors 38 are not concerned with heat release, but on the contrary with efficient heat supply via the nubs 24 (25), because the temperature sensors 38 are intended to detect the temperature as precisely as possible, particularly at the fluid outlet.

This aspect of the invention results in the following advantages:
an adhesive 10 with comparatively lower thermal conductivity can be used, which results in a cost advantage per quantity of adhesive applied;
a greater layer thickness or thickness of the joining gap can be accepted when the layer thickness away from the nubs is increased, which results in increased process capability or a larger tolerance window for the layer thickness;
the affected electronic components can be replaced by alternative components, e.g., with lower costs or higher performance, which in turn is made possible by a higher permissible power dissipation;
the service life of the thermally stressed electronic components can be increased;
temperature sensors can be better connected to the point to be measured (e.g., heat exchanger), which ensures greater accuracy and response time of the measurement.

### LIST OF REFERENCE SIGNS

2 heat exchanger
4 heating conductor
6 heat transfer element
8 insulation element
9 heating elements
10 thermally conductive and elastic adhesive
12 joining gap
14 first side of the insulation element
16 second side of the insulation element
18 medium
20 spacer (inner)
22 spacer (outer)
24 nubs (as spacers)
25 contact surface
26 turbulator
30 edges of the insulation element
32 fluid chamber
34 connection piece, fluid inlet or fluid outlet
36 through-opening
38 temperature sensor
45 power switching component
46 printed circuit board substrate
47 power switching element
48 lead frame (punched grid)
50 bond connections
51 bond connections
54 first side (printed circuit board substrate)
55 second side (printed circuit board substrate)
60 support plate of the heat transfer element

1. A heat exchanger for an electric water heater, comprising:
a heating conductor;
a heat transfer element; and
an insulation element which is arranged between the heating conductor and the heat transfer element, for electrically insulating the heating conductor from the heat transfer element and vice versa;
wherein the insulation element is arranged on the heat transfer element by means of a thermally conductive and elastic adhesive.

2. The heat exchanger as claimed in claim 1,
wherein a joining gap is formed between the heat transfer element and the insulation element, in which the adhesive is arranged.

3. The heat exchanger as claimed in claim 2,
wherein a geometric dimension of the joining gap, in particular at least one of: a thickness thereof and a layer of the adhesive arranged therein, is defined by a number of spacers.

4. The heat exchanger as claimed in claim 3,
wherein the spacers have at least one of: contact points and or surfaces and have at least two different overall heights, wherein first spacers, which are arranged closer to a center of the insulation element, have a comparatively lower overall height, and second spacers, which are located closer to one of the edges of the insulation element, have a greater overall height in comparison, so that a layer thickness of the adhesive near the edges is greater than near the center.

5. The heat exchanger as claimed in claim 3,
wherein the spacers are in the form of nubs formed in a surface of the heat transfer element.

6. The heat exchanger as claimed in claim 5,
wherein a first side of the insulation element faces the nubs and the heating conductor is arranged on an opposite, second side of the insulation element;
wherein a location is defined in the heating conductor at which the greatest heat release can be detected during operation,
wherein one of the nubs is placed in a position on the first side opposite the location of the greatest heat release on the second side.

7. The heat exchanger as claimed in claim 5,
further comprising a power switching component comprising a printed circuit board substrate having a first side and a second side, which is arranged on the heat transfer element in the same way as the insulation element by means of the thermally conductive and elastic adhesive;
wherein at least one of: at least one power switching element and at least one temperature sensor is arranged at a location on the second side of the printed circuit board substrate;
wherein one of the nubs is placed in a position on the first side of the printed circuit board substrate opposite the location of at least one of: the temperature sensor and the power switching element.

8. The heat exchanger as claimed in claim 7,
wherein a geometric dimension of the joining gap is designed based on at least one of the following parameters:
heat conduction of the adhesive;
thermal expansion of the insulation element and the heat transfer element;
a stretchability of the adhesive;
an operating temperature of the heat exchanger;
a continuous operating temperature of the adhesive; and
an adhesion property of the adhesive on the materials of the insulation element and the heat transfer element.

9. The heat exchanger as claimed in claim 8,
wherein the heat transfer element is arranged on a first side of the insulation element and the heating conductor is arranged on a second side of the insulation element wherein the first side is opposite the second side.

10. The heat exchanger as claimed in claim 9,
wherein the insulation element at least one of: comprises a ceramic and is made of a ceramic.

11. An electric water heater comprising a heat exchanger, wherein the heat exchanger comprises:
a heating conductor;
a heat transfer element; and
an insulation element, which is arranged between the heating conductor and the heat transfer element, for electrically insulating the heating conductor from the heat transfer element and vice versa;
wherein the insulation element is arranged on the heat transfer element by means of a thermally conductive and elastic adhesive.

12. A method for manufacturing a heat exchanger, the method comprising the following steps:
arranging a heating conductor on an insulation element;
providing a heat transfer element;
applying a thermally conductive and elastic adhesive on at least one of: one side of the heat transfer element and on one side of the insulation element on which the heating conductor is not arranged;
arranging and bonding the heat transfer element to the insulation element by means of the applied adhesive.

13. The method as claimed in claim 12, further comprising the steps of:
defining a joining gap between the heat transfer element and the insulation element; and
arranging the adhesive in the joining gap.

14. The method as claimed in claim 13, further comprising the step of:
designing a geometric dimension of the joining gap based on at least one of the following parameters:
thermal conduction of the adhesive;
thermal expansion of the insulation element and the heat transfer element;
a stretchability of the adhesive;
an operating temperature of the heat exchanger;
a continuous operating temperature of the adhesive; and
an adhesive property of the adhesive on the materials of the insulation element and the heat transfer element.

15. (canceled)
